(19) United States
(12) Patent Application Publication
(10) Pub. No.: US 2017/0126489 A1
(43) Pub. Date: May 4, 2017

(54) Auto-Commissioning of Lighting Resources

(71) Applicant: Nimbus 9, Inc., Colorado Springs, CO (US)

(72) Inventors: Lucas Schiff, Monument, CO (US); Andrew Hutchison, Colorado Springs, CO (US)

(21) Appl. No.: 15/340,873

(22) Filed: Nov. 1, 2016

Related U.S. Application Data
(60) Provisional application No. 62/249,472, filed on Nov. 2, 2015.

(51) Int. Cl. H04L 12/24; H04L 29/08

(52) U.S. Cl. CPC H04L 41/0803; H04L 67/125; H04L 67/10

(57) ABSTRACT

Disclosed are systems, methods, and software for to minimizing the impact of complexity and granularity to end users of a control and automation solution, while keeping the benefits of having this level of control at least in part by joining large numbers of devices to a network and account, and adding them to specific zones or areas through easy to use interfaces and logic built into the system or commissioning application. Using these systems, methods and software allows for relatively quick, easy, and inexpensive configuration or reconfiguration of defined locations, areas, etc.

### CROSS REFERENCE TO RELATED APPLICATIONS

This application claims priority to and benefit from, provisional patent application Ser. No. 62/249,472, entitled “Auto-Commissioning of Lighting Resources”, filed Nov. 2, 2015, which is incorporated by reference for all purposes.

### BACKGROUND

Lighting remains to be one of the most difficult devices to commission in large quantities when applied to building automation and controls. Given the volume of lighting devices associated with any particular type of building structure from residential housing to large high-rise commercial buildings and the lack of a simple and effective commissioning system or application has been a major factor limiting market saturation of controls and automation to just 1%.

In the past, lighting controls have been limited to only electrical circuit levels of granularity. With the advent of wireless technology and costs being reduced to the point of being able to incorporate into individual lights and fixtures, the level of control and granularity has increased exponentially. This however comes with the cost of more complexity.

### OVERVIEW

The purpose of this invention is to minimize the impact of complexity and granularity to end users of a control and automation solution, while keeping the benefits of having this level of control. One of the most complex components of this type of solution is the way in which an end user commissions large quantities of devices. This invention aims at minimizing all of the complexity of commissioning, joining large numbers of devices to a network and account, and adding them to specific zones or areas through easy to use interfaces and logic built into the system or commissioning application.

### BRIEF DESCRIPTION OF THE DRAWINGS

FIG. 1 is a system diagram illustrating auto-commissioning system, according to an example.

FIG. 2 illustrates a flow diagram for creation of new areas and joining of new devices, according to an example.

FIG. 3 illustrates a database, according to an example.

FIG. 4 illustrates a computing environment according to an example.

FIG. 5 illustrates a fixture, according to an example.

FIG. 6 illustrates an area according to an example.

FIG. 7 illustrates a scene according to an example.

### DESCRIPTION

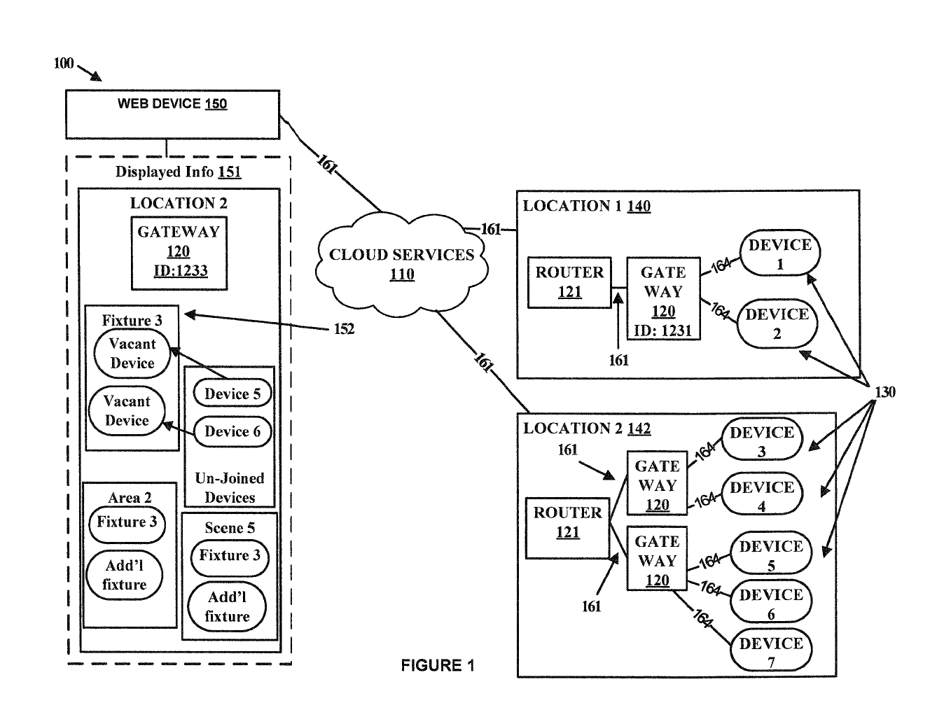

FIG. 1 is a system diagram illustrating the auto-commissioning system 100. System 100 includes cloud services 110, gateway 120, Internet router 121, device 130, location 140, web device 150 and displayed information 151. Web device 150 communicates over link 161 to cloud services 110. Internet router 121 communicates over link 161 to cloud services 110. Gateway 120 communicates over link 161 to Internet Router. Device 130 communicates over link 164 to gateway 120. Web device 150 shows Displayed information 151. Displayed information 151 consists of Location 140 selection, Gateway 120 selection, assignment of Area 152, Fixture 153, Scene 154, allocation of number of Device 130s to join each, and joining of un-joined Device 130s to Fixture 153.

Cloud services 110 are shown as a generic cloud, with multiple underlying services and technologies, which comprise a singular service to an end user. Cloud services 110 refers to anything, which is part of a service that is hosted, managed remotely, and accessible from anywhere via the Internet. Cloud services act as a central resource for communicating with devices 130 and web devices 150. Cloud services provide centralized messaging, computing, data storage, analytics, user management, device 130 management, gateway 120 management, account management, location 140 management, control messaging, asynchronous state messaging and displayed information 151. Cloud services 110 acts as a resource that sends and receives data from multiple gateways and multiple devices and consolidates all data to provide a singular list of devices based on location 140, regardless of how the devices are connected and to which gateway 120. Cloud service 110 also serves as the central point in which the controls and automation system is commissioned, from: user management, gateway 120 management, location 140 management, device 130 management, area management, fixture management, and scene management.

Gateway 120 is a communication bridge that connects device 130 to cloud services 110 via link 164 to Internet router 121. Gateway 120 consists of a messaging translator that can receive communication via any device messaging protocol (i.e. Zigbee, Z-wave, Jennet-ip, Enocean, Wi-Fi, powerline communication, Bacnet, Lonworks, Modbus, etc. . . . ) and translate to a common cloud messaging protocol. Gateway 120 provides a path from any device messaging protocol to cloud services 110.

Internet router 121 is any standard Internet router that takes network traffic (i.e. TCP/IP or UDP) from a private network and provides access to the public Internet. Internet router 121 connects gateway 120 to cloud services 110 by bridging link 161 to link 161.

Device 130 is any electronic device, which has a way to communication via any communication medium (i.e. wireless radio, power-line communication, etc. . . . ), and device messaging protocol. Examples of device 130 may include, but not limited to: light bulbs, lighting drivers, wireless adapters, photo sensors, motion sensors, water/moisture sensors, position sensors, magnetic sensors, switches, temperature sensors, fluid level sensors, thermostats, network sensors, power outlets, circuit breakers, utility meters, display devices, appliances (washer, dryer, refrigerator, dishwasher, audio/visual equipment, toaster, microwave, oven, stove, coffee maker, etc. . . . ), cameras, computers, mobile devices, GPS, locking devices, proximity sensors, security card/badge readers, intrusion sensors, battery sensor, etc. . . . . Device 130 communicates to cloud services 110 via link 164 through gateway 120. Device 130 may be sent messages from cloud services 110 to control it and also may send messages to cloud services 110 for the purpose of communicating state, status, etc. . . . .

Location 140 is any physical site that one or more gateway 120 and device 130 components physically reside. Examples include, but are not limited to: commercial buildings, residential homes, industrial buildings, hospitals, hotels, motels, multiple dwelling units, agricultural facilities, etc. . . . .

Web device 150 is any web-connected device that can send and receive messages and display this information. Web device 150 communicates to cloud services 110 via link 161. Examples may include: smartphones, tablet computers, laptop computers, desktop computers, server computers, etc. . . . . Web device 150 consists of a screen to visualize displayed information 151 and provide control of displayed information 151 via touch or human interface device (i.e. track pad or mouse).

Displayed information 151 is received from cloud services 110 through web device 150. No displayed information 151 is stored on web device 150. It is just visualized information received from cloud services 110. In this way, displayed information 151 is decoupled from any web device 150 and allows user to see any information provided by cloud services 110 without the need to be physically connected. Displayed information 151 can consist of device 130 status, state, location, groups, etc. . . . . Displayed information 151 can consist of area 152, fixture 153, and scene 154 information. Displayed information 151 connects to cloud services 110, which provides a list of devices based on location 140 and has no dependencies on which gateway 120 the device 130 is connected to cloud services 110 through.

Link 161 uses various communication media, such as air, space, metal, optical fiber, or some other signal propagation path, including combinations thereof. Link 161 could use various communication protocols, such as Internet Protocol (IP), Ethernet, Wireless Fidelity (Wi-Fi), Time Division Multiplexing (TDM), Asynchronous Transfer Mode (ATM), Code Division Multiple Access (CDMA), Evolution-Data Optimized (EV-DO), single-carrier radio transmission technology, Frame relay, optical, synchronous optical networking (SONET), or some other communication format, including combinations, improvements, or variations thereof. Link 161 could be a direct link or may include intermediate networks, systems, or devices.

Link 164 is the communication that stems from device 130 and may connect to gateway 120 or directly to cloud services 110. Link 164 uses various communication media, such as air, space, metal, optical fiber or some other signal propagation path, including combinations thereof. Link 164 could use various communications protocols, such as Internet Protocol (IP), Ethernet, Wireless Fidelity (Wi-Fi), Bluetooth, Zigbee, Z-Wave, Enocean, Jennet-IP, NFC, X-bee, 802.15.4, 6LowPAN, TCP/IP, Insteon, ANT, DASH7, NeuRFon, Senceive, WPAN, WirelessHART, Contiki, TinyOS, LONworks, Modbus, BacNet, or some other communication format, including combinations, improvements, or variations thereof. Link 164 could be a direct link or may include intermediate networks, systems, or devices.

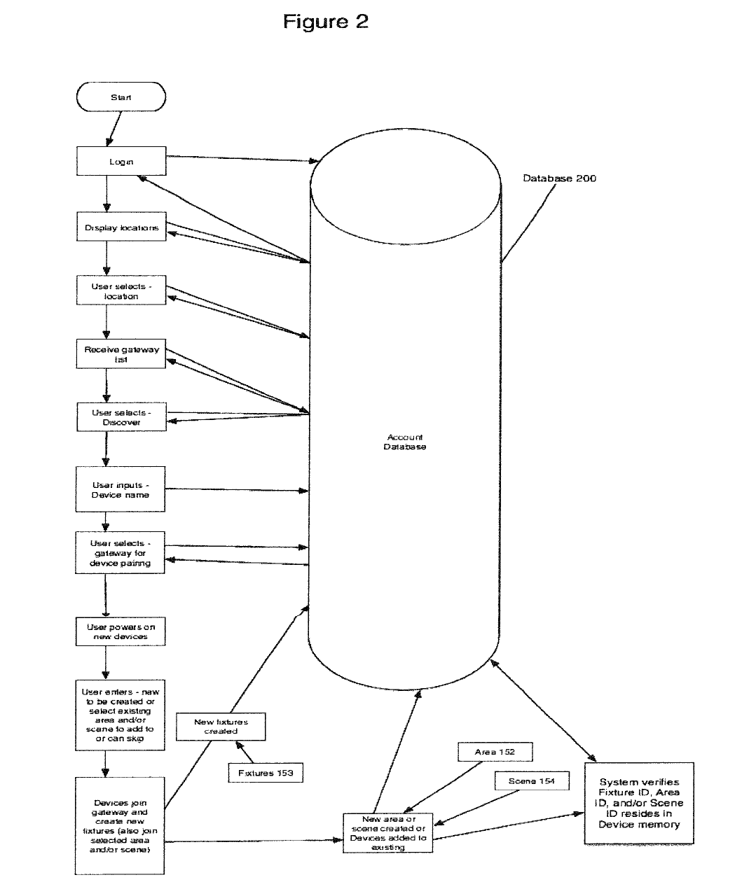

FIG. 2 describes the flow in which an application retrieves, creates and displays information on devices 130, gateways 120, and areas 152 in order to automate the creation of new fixtures 153, areas 152, and joining of new devices 120 onto an account. This is made possible through the use of a consolidated Database 200 with multiple collections. Each collection stores separate data that can then be referenced across each collection. By doing this, we create a simple approach to adding large quantities of devices to an account. The process involves the user to activate the Discovery mode via the User Interface. The user may enter a new fixture 153 name that will help identify them later in the process. This will be applied to all newly discovered fixtures 153 with the addition of a unique number assigned to each new fixture 153. Discovery mode turns on pairing on the gateway 120 so that it is looking for new devices to join. Once new devices are discovered, the process creates a new fixture 153 for each device 130 and allows the user to select to either create a new area 152 or scene 154, or add to an already existing area 152 or scene 154 and create dim level set points for each fixture 152 within the scene 154. The final step is a verification message that is sent from cloud services 110 to verify each device 130 has stored the fixture 153 ID, area 152 ID, and/or scene 154 ID and dim level set point. This gives the user a seamless experience and removes the need to commission each new device directly and automates the process of creating fixtures 153, areas 152, and scenes 154. This process greatly reduces the time needed to setup and commission large installations.

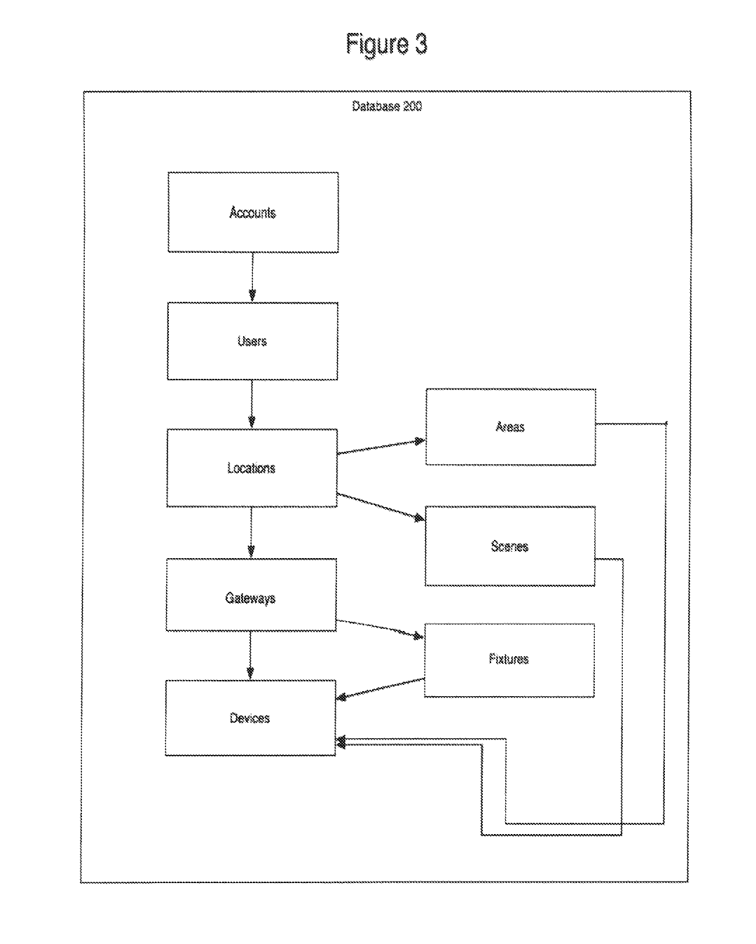

FIG. 3 describes the contents of Database 200. Database 200 consists of multiple collections of data. These collections are defined as Accounts, Users, Locations, Gateways, Devices, Areas, Scenes and Fixtures. Accounts represent the highest level in the data hierarchy. All collections or data grouping fall under a specific account, which helps define access to overall data for an account. Users represent individual user accounts that are part of the overall account. Locations represent the physical sites that fall under an account. An account can have a limitless amount of locations associated with it. Gateways represent the physical Gateways 120 devices that fall under a specific location. Devices represent the Devices 130 that are connected to the Gateways 120 and fall under the gateways collection. Fixtures represent a collection of one or more devices and fall under gateways. Areas represent a collection of one or more fixtures and fall under locations. By doing so, an area is able to have fixtures from any gateway, without regard to physical connection. Scenes represent a collection of one or more fixtures and can store a specific set point and fall under locations. By doing so, a scene is able to have fixtures, with specific set points from any gateway, without regard to physical connection.

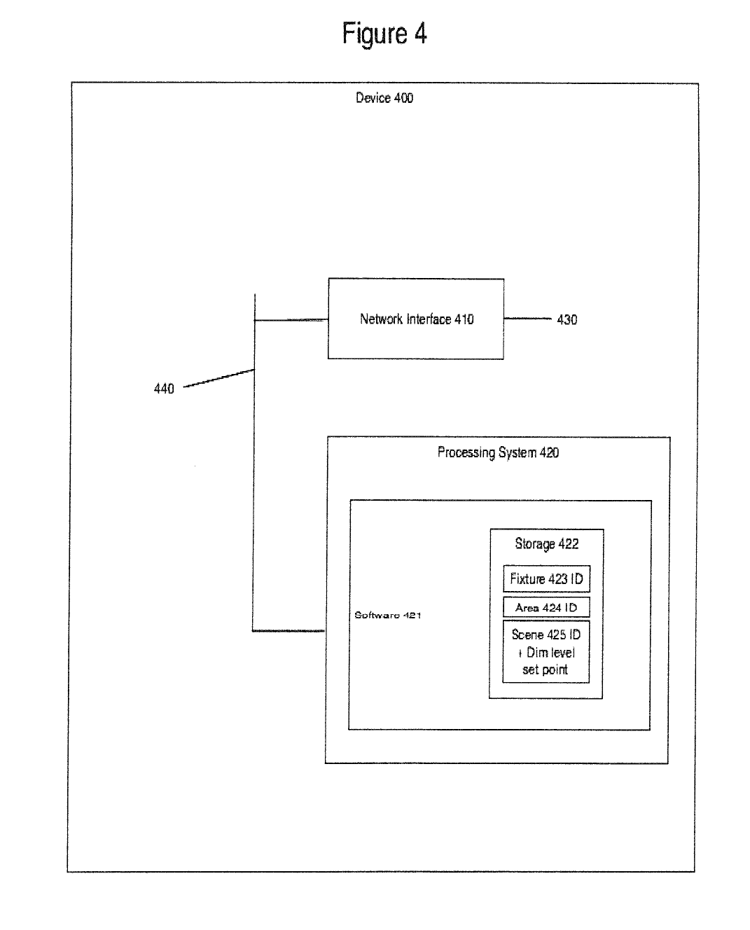

FIG. 4 describes Device 400. Device 400 consists of Network Interface 410, Processing System 420 (which includes Software 421 and Storage 422), External Network 430 and Internal Service Bus 440. Network Interface 410 communicates with Processing System 420 over link Internal Service Bus 440 and communicates externally to Internet Router or via direct Internet connection over link External Network 430. Within the Processing System 420, unique IDs are stored which represent the fixture 423 ID and any associated area 424 IDs and scene 425 IDs and dim level set points. Device 400 may be an example of any computing device used in the system, including but not limited to, cloud services, a user device, server, cell phone, etc.

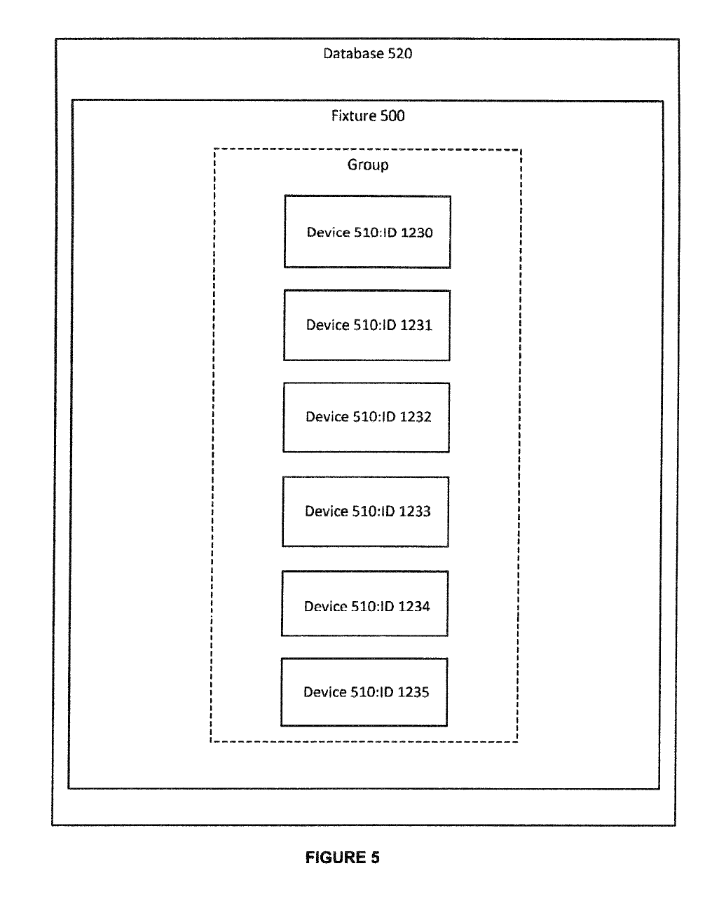

FIG. 5 describes Fixture 500. Fixture 500 consists of a group of Devices 510. Fixture 500 is a collection in Database 520.

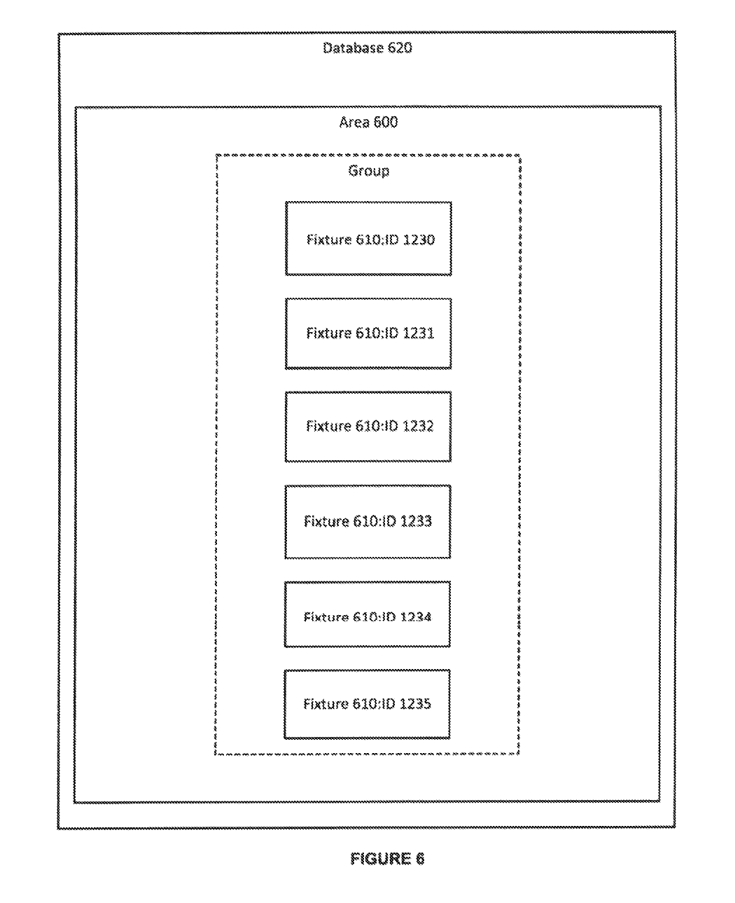

FIG. 6 describes Area 600. Area 600 consists of a group of Fixtures 610. Any Fixture 610 can be a part of an unlimited number of Areas 600. Area 600 is a collection in Database 620.

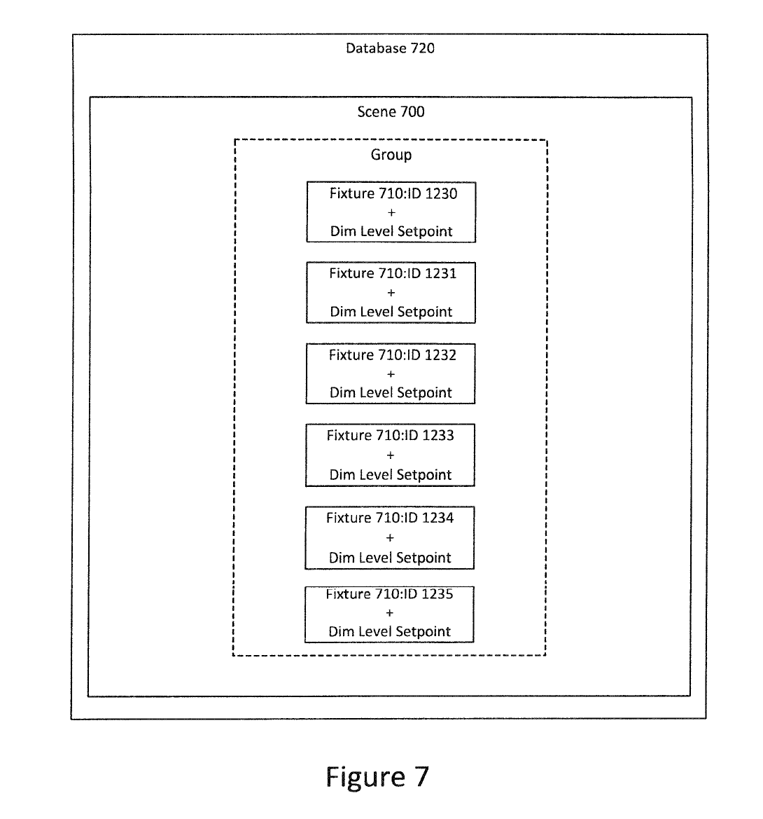

FIG. 7 describes Scene 700. Scene 700 consists of a group of Fixtures 710 with dim level set points specified for each individual Fixture 710. Any Fixture 710 can be a part of an unlimited number of Scenes 700. Scene 700 is a collection in Database 720. Each Fixture 710 may include a unique identifier (ID), which may make them individually addressable.

The included descriptions and figures depict specific implementations to teach those skilled in the art how to make and use the various modes. For the purpose of teaching inventive principles, some conventional aspects have been simplified or omitted. Those skilled in the art will appreciate variations from these implementations that fall within the spirit and scope of the invention. Those skilled in the art will also appreciate that the features described above can be combined in various ways to form multiple implementations. As a result, the invention is not limited to the specific implementations described above, but only by the claims and their equivalents.

1. A method for configuring lighting devices using a cloud infrastructure, comprising;
receiving user configuration information for one or more devices to be controlled from a user, and device information from the devices to be controlled at a computing device;
grouping the devices into a group, thereby creating group information;
storing the group and user and device configuration information at a memory;
sending the received or stored user or device configuration information to a first group of devices, wherein the configuration information is used at least in part to configure the first group of devices; and
sending the received or stored user and device configuration information to a second group of devices if it is determined the second group of devices requires configuration.

2. The method of claim 1, further comprising configuring a second group of devices at least in part by sending the received or stored user and device configuration information to the second group of devices if it is determined the first group of devices is not functioning properly.

3. The method of claim 1, wherein the computing device comprises cloud services.

4. The method of claim 1, wherein first device or the second device comprises a fixture group.

5. The method of claim 1, wherein the group comprises a scene, fixture, or area.

6. The method of claim 1, wherein the devices may be controlled based at least in part on the group information.

7. The method of claim 1, wherein the devices may be controlled based at least in part on the device information.

8. A non-volatile computer readable medium, having stored thereon instructions, which if executed by a processor, cause the processor to:
receive user configuration information for one or more devices to be controlled from a user, and device information from one or more devices to be controlled at a computing device;
group the devices into a group thereby creating group information;
store the group and user and device configuration information at a memory;
send the received or stored user and device configuration information to a first group of devices, wherein the user or device configuration information is used at least in part to configure the first group of devices; and
send the received or stored user and device configuration information to a second group of devices if it is determined the second group of devices requires configuration.

9. The computer readable medium of claim 8, having further instructions wherein the computing device comprises cloud services.

10. The computer readable medium of claim 8, having further instructions wherein first group of devices or the second group of devices comprises a fixture, scene, and/or area.

11. The computer readable medium of claim 8 having further instructions, wherein the group comprises a scene, fixture, or area.

12. The computer readable medium of claim 8, having further instructions, wherein the devices may be controlled based at least in part on the group information.

13. The computer readable medium of claim 8, having further instructions wherein the devices may be controlled based at least in part on the device information.

14. A system for generally auto-commissioning lighting devices, comprising:
a computing device capable of receiving user configuration information for one or more devices to be controlled from a user device, and device configuration information from one or more devices to be controlled at the computing device, grouping the devices into a group thereby creating group information; storing the group and user and device configuration information at a memory, sending the received or stored user and device configuration information to a first group of devices, wherein the user and device configuration information is used at least in part to configure the first group of devices; and sending the received or stored user and device configuration information to a second group of devices if it is determined the second group of devices requires configuration;
wherein the first device or second device comprise a fixture,
wherein the computing device comprises cloud infrastructure.

15. The system of claim 14, wherein the group comprises a scene, fixture, or area.

16. The system of claim 14, wherein the devices may be controlled based at least in part on the group information.

17. The system of claim 14, wherein the devices may be controlled based at least in part on the device information.
